(19) United States
(12) Patent Application Publication
(10) Pub. No.: US 2010/0067812 A1
(43) Pub. Date: Mar. 18, 2010

(54) IMAGE COMPRESSION METHOD USING BLOCK TRUNCATION CODING

(75) Inventors: Jing-Ming Guo, Taipei County (TW); Min-Feng Wu, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: National Taiwan University of Science and Technology, Taipei (TW)

(21) Appl. No.: 12/261,059

(22) Filed: Oct. 30, 2008

(30) Foreign Application Priority Data
Sep. 12, 2008 (TW) 97135231

(51) Int. Cl. G06K 9/00

(52) U.S. Cl. 382/243

(57) ABSTRACT

An image compression method is provided. First, an image including a plurality of blocks is received and each block includes a plurality of pixels. Next, an order dithering array within a preset range is generated, which includes a plurality of elements. Then, values of the elements in the order dithering array are respectively mapped to a plurality of mapping values according to a gray scale range of each block. In each block, each pixel value is quantized to a first digital value or a second digital value according to a result of comparing each pixel value with the corresponding mapping value. Hence, a bit rate of the image is efficiently compressed, and features of the original image are preserved inside the compressed image.

### CROSS-REFERENCE TO RELATED APPLICATION

This application claims the priority benefit of Taiwan application serial no. 97135231, filed on Sep. 12, 2008. The entirety of the above-mentioned patent application is hereby incorporated by reference herein and made a part of this specification.

### BACKGROUND OF THE INVENTION

1. Field of the Invention

The present invention generally relates to an image compression method, in particular, to an image compression method using block truncation coding (BTC) performed by adopting order dithering arrays.

2. Description of Related Art

Image compression refers to reducing a data quantity of a digital image to such a level that it is capable of being supported by a storage medium or a transmission medium. The BTC is an image compression manner with a high compression ratio and a low complexity. The BTC divides an original image into a plurality of not-repeated sub-images, and extracts features of the sub-images through a statistic manner, so as to quantize pixels in the sub-images, thereby reducing the data quantity of the image.

In the typical BTC, a pixel average value and a standard deviation of each sub-image are two important parameters, and the parameters may be varied according to different sub-images, for reflecting the features of the sub-images. For example, as for a sub-image of 4×4 pixels, when a pixel value in the sub-image is greater than or equal to a pixel average value, the pixel value is coded to “1”, and otherwise, it is coded to “0”. “1” and “0” respectively represent two quantized values “a” and “b”. “a” and “b” are relevant to the pixel average value and the standard deviation of the sub-image, which are respectively represented by mathematical expressions as a= x̅− σ̅\sqrt{q/(m−q)} and b= x̅+ σ̅\sqrt{(m−q)/q}, in which x̅ and σ̅ are respectively the pixel average value and the standard deviation, and m and q are respectively a number of pixels in the sub-image and a number of the pixels greater than or equal to the average value in the sub-image.

Therefore, as for each sub-image, it can re-establish the image merely through storing a bit map of 4×4 bits, and the pixel average value and the standard deviation of the sub-image. Briefly, in the image compression method, the pixel average value of the sub-image where each pixel belongs to is taken as a threshold value for making reference, so as to quantize each pixel value to one of the two quantized values. The quantized values are obtained by calculating the pixel average value and the standard deviation of the sub-image where each pixel belongs to.

As compared with other image compression methods, the BTC algorithm has a lower complexity. However, when the pixel average value and the standard deviation of the sub-image are calculated, a great number of additions, multiplications, and radical operations are required, so it is relatively difficult to be realized by using hardware. In addition, the BTC can control the image compression ratio by designing the sub-images into different sizes, but the quality of the compressed images may be deteriorated with the increasing of the compression ratio. What's worse, a blocking effect may be generated. The blocking effect is a discontinuous phenomenon occurring between two neighbouring sub-images. Each sub-image may adopt the pixel average value as the reference for re-establishing the image, and thus, as the size of the sub-image is increased, the compressed image becomes fuzzier. As a result, the human eyes cannot recognize the features of the original image, for example, edges or profiles.

### SUMMARY OF THE INVENTION

Accordingly, the present invention is directed to an image compression method using BTC, in which a compressed image satisfies a low pass characteristic of the vision of human eyes, and a blocking effect generated by the BTC is also greatly reduced. In addition, the image compression method has various advantages such as a low complexity, and a high image quality.

As embodied and broadly described herein, an image compression method using BTC is provided in the present invention, which includes the following steps. First, an image including a plurality of blocks is received, in which each block includes a plurality of pixels. Next, an order dithering array within a preset range is generated. The order dithering array includes a plurality of elements, and the elements are respectively corresponding to the pixels. According to a gray scale range of each block, values of the elements are respectively mapped to a plurality of mapping values within the gray scale range. In each block, each pixel value is quantized to a first digital value or a second digital value according to a result of comparing each pixel value with the corresponding mapping value.

The present invention further provides an image compression method using BTC, which includes the following steps. First, an image including a plurality of blocks is received, in which each block includes a plurality of pixels. Next, a plurality of order dithering arrays within a plurality of preset ranges is respectively generated. Each order dithering array includes a plurality of elements, and the elements are respectively corresponding to the pixels. According to a gray scale range of each block, one of the order dithering arrays is selected, and values of the elements in the selected order dithering array are respectively mapped to a plurality of mapping values within the gray scale range. In each block, each pixel value is quantized to a first digital value or a second digital value according to a result of comparing each pixel value with the corresponding mapping value.

In an embodiment of the image compression method, when the pixel value is greater than a threshold value, the pixel value is quantized to the first digital value, and otherwise, it is quantized to the second digital value. The threshold value is relevant to the mapping value corresponding to the pixel.

In an embodiment of the image compression method, the first digital value and the second digital value are respectively a maximum value and a minimum value of the pixels in each block.

In the present invention, the first or second digital value is adopted to represent the pixel value in each image block. In addition, since the BTC may generate the blocking effect, the threshold value, as a reference for quantizing each pixel, is appropriately adjusted through matching with the order dithering array, thereby modifying the above-mentioned problem. In each block, the maximum value and the minimum value of the pixels are respectively used as the first digital value and the second digital value, such that not only the quality of the compressed image is improved, but also the operation complexity is reduced.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic view of an order dithering array according to an embodiment of the present invention

FIG. 1B is a schematic view of a mapped order dithering array according to an embodiment of the present invention.

FIG. 2 is a schematic view of image blocks according to an embodiment of the present invention.

FIG. 3 is a flow chart of an image compression method according to an embodiment of the present invention.

FIG. 4 is a flow chart of an image compression method according to another embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

In this embodiment, based on a BTC technique, an image compression process is performed on an image including a plurality of blocks one block by another, so as to quantize each pixel value in the block to a first digital value or a second digital value. Each block has M×N pixels, and M and N are positive integers greater than 1.

Conventionally, a pixel average value of each block is used as a threshold value for making reference, so as to determine whether each pixel value is quantized to the first or second digital value. Moreover, the conventionally used quantized values are obtained by computing the pixel average value and a standard deviation of each block. The larger the used block is, the more easily the blocking effect occurs, and as a result, the quality of the compressed image is deteriorated. In a void and cluster technique, an order dithering array may generate a color depth illusion in the image by using limited color palettes. The pixels of the color palettes are adjacent to each other, so as to generate a diffusion effect, and thus, the human eyes can perceive the colors close to that of the original image. Therefore, in this embodiment, the order dithering array is adopted to appropriately adjust the threshold value that serves as a reference for each pixel.

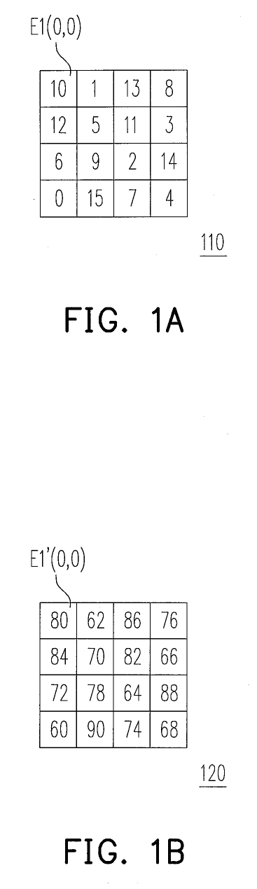

It is assumed that each block in the image has 4×4 pixels P(X,Y), i.e. M=4 and N=4, in which 0≦X≦M and 0≦Y≦N. FIG. 1A is a schematic view of an order dithering array according to an embodiment of the present invention. Referring to FIG. 1A, a size of an order dithering array 110 is the same as that of each block. Elements E1(X,Y) included in the order dithering array 110 respectively correspond to the pixels P(X,Y), and values of the elements E1(X,Y) are within a preset range. In this embodiment, according to the preset range of the order dithering array 110, 1^{st} to (M×N)^{th} preset values may be generated, in which the Q^{th} preset value is equal to Kₘᵢₙ+Q×(Kₘₐₓ−Kₘᵢₙ)/(M×N−1)−1, Q is a positive integer, 1≦Q≦(M×N), and Kₘₐₓ and Kₘᵢₙ are respectively an upper limit value and a lower limit value of the preset range. For the ease of description, it is assumed that the preset range of the order dithering array 110 is 0-15, i.e., Kₘₐₓ=15 and Kₘᵢₙ=0, and accordingly, the 1^{st} to 16^{th} preset values are respectively 0, 1, . . . , 15. Those of ordinary skill in the art should know the manner of generating the order dithering array, so it is not described here.

Generally, each pixel is represented by 8 bits, that is, each pixel may represent a gray scale of 0-255. In the BTC technique, the pixel values in each block may be quantized to the first digital value or the second digital value. When the represented gray scale number is reduced, the compressed image may generate an artifact and the blocking effect. Therefore, in each block, the threshold value, serving as a reference for each pixel, is appropriately adjusted through the order dithering array, thereby efficiently eliminating the artifact and the blocking effect, and preserving the features of the original image, for example, edges and profiles. The manner of adjusting the threshold value serving as a reference for each pixel value, and the manner of quantizing each pixel value are described below in detail.

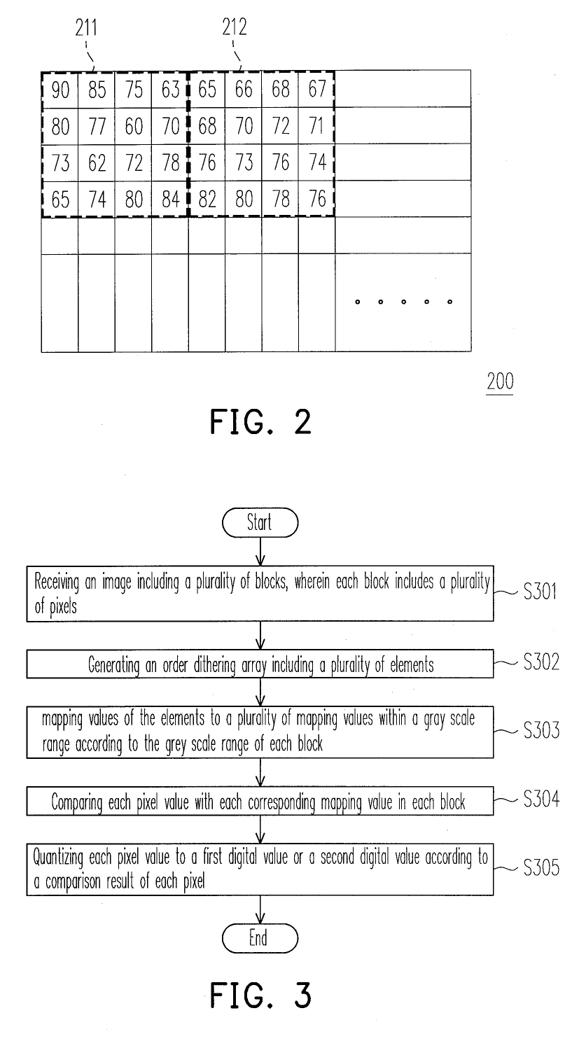

FIG. 2 is a schematic view of image blocks according to an embodiment of the present invention. Referring to FIG. 2, according to the above assumption, an image 200 includes a plurality of blocks having 4×4 pixels (only two blocks 211 and 212 are shown herein). In this embodiment, according to a gray scale range of each block, the values of the elements E1(X,Y) in the order dithering array are mapped to mapping values in the gray scale range. Here, a linear mapping manner is adopted, the mapping value of each element E1(X,Y) is equal to Pₘᵢₙ+(E1(X,Y)−Kₘᵢₙ)×(Pₘₐₓ−Pₘᵢₙ)/(Kₘₐₓ−Kₘᵢₙ), in which Pₘₐₓ and Pₘᵢₙ are respectively an upper limit value and a lower limit value of the gray scale range, i.e., a maximum value and a minimum value of the pixels in each block. For example, as for the block 211, by using the above expression, the values of the elements E1(X,Y) in the order dithering array 110 may be mapped to the mapping values within the gray scale range of 60-90 of the block 211, for example, the values of the elements E1(3,2) and E1(1,2) are mapped to the mapping values 74 and 82 respectively.

Referring to FIG. 1B, the mapped order dithering array is marked as 120, and the mapped elements E1(X,Y) are marked as E1′(X,Y). When the values of the pixels P(X,Y) in each block are quantized, the mapping values of the elements E1(X,Y) may be taken as the threshold values for making reference. That is to say, in each block, when the value of the pixel P(X,Y) is greater than the threshold value, the value of the pixel P(X,Y) is quantized to the first digital value, for example, the maximum value Pₘₐₓ of the pixels in each block. On the contrary, when the value of the pixel P(X,Y) is smaller than the threshold value, the value of the pixel P(X,Y) is quantized to the second digital value, for example, the minimum value Pₘᵢₙ of the pixels in each block. It is represented by the mathematical expression as follows.

$${P}^{′} ( X , Y ) = \{ \begin{matrix}{P}_{max} , & P ( X , Y ) \geq E {1}^{′} ( X , Y ) \\ {P}_{min} , & P ( X , Y ) < E {1}^{′} ( X , Y )\end{matrix} ,$$

in which P′(X, Y) is the quantized value of the pixel P(X,Y).

It may be known from experiments that, through adjusting the threshold value as a reference for quantizing each pixel by adopting the order dithering array, and adopting the maximum value and the minimum value of the pixels in each block as the first and second digital values, not only a peak signal to noise ratio (PSNR) of the compressed image is improved, but also the blocking effect is effectively eliminated, and thus, the image quality is improved. During the image compression, it is possible to obtain the maximum value and the minimum value of the pixels in each block as the first and second digital values without performing a great amount of operations, thereby greatly reducing the complexity and the operation amount.

Table 1 is a comparison table between the image compression method of this embodiment and the conventional image compression method using BTC, in which the compressed image is a Lenna standard test image widely used in this technical field. As known from Table 1 that, in the conventional image compression method, as the size of the block is increased, the PSNR of the image is reduced, whereas the image compression method of this embodiment achieves better PSNR under different situations of blocks with different sizes.

TABLE 1
Comparison between the image compression method
of this embodiment and the conventional image
compression method using BTC

| | Conventional Image | Image Compression Method of |
|---|---|---|
| Block Size | Compression Method | This Embodiment |
| 8 × 8 | 40.81 dB | 39.06 dB |
| 16 × 16 | 33.77 dB | 37.01 dB |
| 32 × 32 | 29.23 dB | 35.40 dB |

According to the above embodiment, a following flow may be concluded. FIG. 3 is a flow chart of an image compression method according to an embodiment of the present invention. Referring to FIG. 3, first, an image including a plurality of blocks is received (Step S301), in which each block includes a plurality of pixels. Next, an order dithering array within a preset range is generated (Step S302). The order dithering array includes a plurality of elements respectively corresponding to the pixels. According to a gray scale range of each block, values of the elements are respectively mapped to a plurality of mapping values within the gray scale range (Step S303). In each block, each pixel value is compared with the corresponding mapping value (Step S304), and each pixel value is quantized to a first digital value or a second digital value according to a comparison result (Step S305).

It should be noted that, although it is assumed that the order dithering array 110 is within the preset range of 0-15 in FIG. 1, those of ordinary skill in the art may set the order dithering array to be within different preset ranges, for example, 0-5, and 2-17 etc., and set different sizes of image blocks. According to the teaching of the above embodiments, those of ordinary skill in the art may fill preset values satisfying the requirement of the pixel number in the block into the order dithering array, so it is not limited herein.

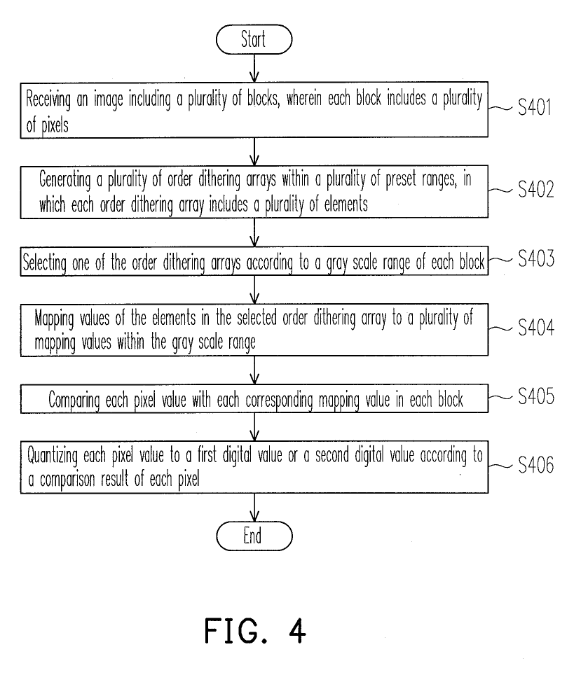

In order to enable those of ordinary skill in the art to easily implement the present invention, another embodiment is given below for description. FIG. 4 is a flow chart of an image compression method according to another embodiment of the present invention. First, an image including a plurality of blocks is received (Step S401), in which each block includes a plurality of pixels. Generally, the pixel adopting 8 bits represents a gray scale of 0-255, that is to say, a gray scale range of each block in the image is 0-255 at the maximum. Therefore, in this embodiment, a plurality of order dithering arrays within a plurality of preset ranges is generated respectively (Step S402), for example, 0-1, 0-2, 0-3, . . . , 0-255, as well as other preset ranges, in which each order dithering array includes a plurality of elements respectively corresponding to the pixels. In terms of the realization of hardware, the order dithering arrays within different preset ranges may be generated before hand, and stored in storage media of a look-up table.

Next, according to a gray scale range of each block in the image, one of the order dithering arrays matching with the gray scale range is selected (Step S403). For example, it is assumed that the gray scale range of the block is 46-70, so that the order dithering array within the preset range of 0-24 is selected. Here, the preset range of the selected order dithering array is the same as the gray scale range of each block, so the elements in the order dithering array can be directly mapped to a plurality of mapping values within the gray scale range of each block, without performing a great amount of operations (Step S404). Then, in each block, each pixel value is compared with the corresponding mapping value (Step S405), and the pixel value is quantized to a first digital value or a second digital value accordingly (Step S406).

To sum up, in the above embodiments, the threshold value as a reference for quantizing the pixel in each block is appropriately adjusted through matching with the order dithering array, thereby eliminating the blocking effect, and preserving the features of the original image. In the above embodiments, the maximum value and the minimum value of the pixels in each block are adopted to represent the pixel values in each image block, such that not only the complexity and the operation amount are reduced. The person may sense an image similar to a void-and-cluster image when viewing the compressed image with human eyes at a short distance, that is to say, the maximum value and the minimum value of the pixels in each block are used to create illusions with different gray scale depths. The compressed image may be applied to a computer image system, an image monitoring system, and a digital watermarking, so as to achieve a high image quality with a low complexity. When viewing the compressed image at a certain distance, the person may not sense the difference between the compressed image and the original image, and may also view the features of the original image, for example, edges and profiles, in the compressed image.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An image compression method, comprising:
receiving an image, wherein the image comprises a plurality of blocks, each block comprises M×N pixels, and M and N are positive integers greater than 1;
generating an order dithering array, wherein the order dithering array is within a preset range, and the order dithering array comprises a plurality of elements respectively corresponding to the pixels;
mapping values of the elements to a plurality of mapping values within the gray scale range respectively according to a gray scale range of each block;
comparing each pixel value with each corresponding mapping value in each block; and
quantizing each pixel value to a first digital value or a second digital value according to a comparison result of each pixel.

2. The image compression method according to claim 1, wherein a value of the preset range is equal to (M×N−1).

3. The image compression method according to claim 1, wherein each mapping value is Pₘᵢₙ+(E1−Kₘᵢₙ)×(Pₘₐₓ−Pₘᵢₙ)/(Kₘₐₓ−Kₘᵢₙ), E1 is the value of each element, Pₘₐₓ and Pₘᵢₙ are respectively an upper limit value and a lower limit value of the gray scale range, and Kₘₐₓ and Kₘᵢₙ are respectively an upper limit value and a lower limit value of the preset range.

4. The image compression method according to claim 1, wherein the step of quantizing each pixel value to the first digital value or the second digital value according to the comparison result of each pixel further comprises:
quantizing each pixel value to the first digital value when each pixel value is greater than or equal to a threshold value, wherein the threshold value is relevant to each mapping value corresponding to each pixel; and
quantizing each pixel value to the second digital value when each pixel value is smaller than the threshold value.

5. The image compression method according to claim 1, wherein the first digital value is a maximum value of the pixels in each block, and the second digital value is a minimum value of the pixels in each block.

6. An image compression method using block truncation coding (BTC), comprising:
receiving an image, wherein the image comprises a plurality of blocks, each block comprises M×N pixels, and M and N are positive integers greater than 1;
generating a plurality of order dithering arrays, wherein the order dithering arrays are respectively within a plurality of preset ranges, and each order dithering array comprises a plurality of elements respectively corresponding to the pixels;
selecting one of the order dithering arrays according to a gray scale range of each block;
mapping values of the elements in the selected order dithering array to a plurality of mapping values within the gray scale range respectively;
comparing each pixel value with each corresponding mapping value in each block; and
quantizing each pixel value to a first digital value or a second digital value according to a comparison result of each pixel.

7. The image compression method according to claim 6, wherein the preset range corresponding to the selected order dithering array is matched with the gray scale range.

8. The image compression method according to claim 6, wherein each mapping value corresponding to each element is Pₘᵢₙ+(E1−Kₘᵢₙ)×(Pₘₐₓ−Pₘᵢₙ)/(Kₘₐₓ−Kₘᵢₙ), E1 is the value of each element, Pₘₐₓ and Pₘᵢₙ are respectively an upper limit value and a lower limit value of the gray scale range, and Kₘₐₓ and Kₘᵢₙ are respectively an upper limit value and a lower limit value of each preset range corresponding to each order dithering array.

9. The image compression method according to claim 6, wherein the step of quantizing each pixel value to the first digital value or the second digital value according to the comparison result of each pixel further comprises:
quantizing each pixel value to the first digital value when each pixel value is greater than or equal to a threshold value, wherein the threshold value is relevant to each mapping value corresponding to each pixel; and
quantizing each pixel value to the second digital value when each pixel value is smaller than the threshold value.

10. The image compression method according to claim 6, wherein the first digital value is a maximum value of the pixels in each block, and the second digital value is a minimum value of the pixels in each block.
